(19) United States
(12) Patent Application Publication
(10) Pub. No.: US 2017/0313559 A1
(43) Pub. Date: Nov. 2, 2017

(54) POSITIONAL MONITORING OF VEHICLE LIFTS

(71) Applicant: Vehicle Service Group, LLC, Madison, IN (US)

(72) Inventor: Gerry D. Lauderbaugh, Dupont, IN (US)

(73) Assignee: Vehicle Service Group, LLC, Madison, IN (US)

(21) Appl. No.: 15/245,434

(22) Filed: Aug. 24, 2016

Related U.S. Application Data
(63) Continuation-in-part of application No. 15/142,934, filed on Apr. 29, 2016.

(51) Int. Cl. B66F 3/25; B66F 3/24; B66F 7/16

(52) U.S. Cl. CPC B66F 3/25; B66F 7/16; B66F 3/24; B66F 2700/12; B66F 2700/055

(57) ABSTRACT

A vehicle lift includes a vehicle support member, a cylinder, and a controller. A linear transducer—such as a string potentiometer—is (preferably removably) positioned inside the cylinder. The transducer detects the position of the cylinder and sends a corresponding signal to a controller that controls the height of the support member in response to the signal. The cylinder acts on the vehicle support member through a scissor mechanism, parallelogram linkage, or straight vertical hydraulic lifting.

### REFERENCE TO RELATED APPLICATION

This application claims priority to and is a continuation-in-part of U.S. patent application Ser. No. 15/142,934, filed Apr. 29, 2016, with title ROTATIONAL POSITIONAL MONITORING OF VEHICLE LIFTS, which is hereby incorporated by reference herein.

### BACKGROUND

Vehicle lift systems may be used to lift various kinds of vehicles relative to the ground. Some vehicle lifts operate by positioning two runways at, or near, a shop floor level. The vehicle may be then driven or rolled onto the runways, allowing the runways to support the vehicle. The underside of each runway may be attached to a plurality of hydraulically driven lifting assemblies. The lifting assemblies may be actuated to raise the runways and the vehicle to a desired height. Afterward, the vehicle may then be lowered once the user has completed his or her task requiring the vehicle lift. In some cases, the lifting assemblies may comprise a single elongated member which may rotate relative to the floor to pivot the runways upwardly. In other cases, the lifting assemblies may comprise a plurality of linkages which pivot relative to one another to cause the runways to rise upwardly, similar to a pair of scissors.

Other vehicle lift systems are formed by a set of mobile, above-ground lift columns. An example of a mobile column lift system is the MACH 4 Mobile Column Lift System by Rotary Lift of Madison, Indiana. Each mobile column may include a hydraulically driven lifting assembly. The mobile columns may be readily positioned in relation to the vehicle. The mobile columns may then be activated such that lifting assemblies actuate to raise the vehicle from the ground in a coordinated/synchronized fashion. The mobile columns may be controlled through wireless communication with a wireless control center. The wireless control center may associate with each mobile column in order to form a synchronized lift.

While a variety of systems and configurations have been made and used to control lift systems, it is believed that no one prior to the inventors has made or used the invention described herein.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1A shows a perspective view of an exemplary hydraulic cylinder assembly in a withdrawn position;

FIG. 1B shows a perspective view of the hydraulic cylinder assembly of FIG. 1A in an expanded position;

FIG. 2 shows a partial cross-sectional exploded view of the hydraulic cylinder assembly of FIG. 1A;

FIG. 3 shows a cross-sectional perspective view of the hydraulic cylinder assembly of FIG. 1A;

FIG. 4A shows a cross-sectional elevation view of the hydraulic cylinder assembly of FIG. 1A;

FIG. 4B shows a cross-sectional elevation view of the hydraulic cylinder assembly of FIG. 1A and 1B in a partially expanded position;

FIG. 4C shows a cross-sectional elevation view of the hydraulic cylinder assembly of FIG. 1B;

FIG. 5 shows a perspective view of an exemplary vehicle lift with the hydraulic cylinder assembly of FIG. 1A;

FIG. 6A shows a side elevational view of the vehicle lift of FIG. 5 in a retracted position;

FIG. 6B shows a side elevational view of the vehicle lift of FIG. 5 is an extended position;

FIG. 7 shows an exploded perspective view of a lift assembly of the vehicle lift of FIG. 5;

FIG. 8A shows a perspective view of the lift assembly of FIG. 7, with the lift assembly in a retracted position;

FIG. 8B shows a perspective view of the lift assembly of FIG. 7, with the lift assembly in an extended position;

FIG. 9A shows a cross-sectional elevation view of an alternative hydraulic cylinder assembly in a retracted position, where the alternative hydraulic cylinder assembly may be used in place of the hydraulic cylinder assembly of FIG. 1A;

FIG. 9B shows a cross-sectional elevation view of the hydraulic cylinder assembly of FIG. 9A in a partially expanded position;

FIG. 9C shows a cross-sectional elevation view of the hydraulic cylinder assembly of FIG. 9A in an expanded position;

FIG. 10A shows a cross-sectional elevation view of another alterative hydraulic cylinder assembly in a retracted position, where the alternative hydraulic cylinder assembly may be used in place of the hydraulic cylinder assembly of FIG. 1A;

FIG. 10B shows a cross-sectional elevation view of the hydraulic cylinder assembly of FIG. 10A in a partially expanded position;

FIG. 10C shows a cross-sectional elevation view of the hydraulic cylinder assembly of FIG. 10A in an expanded position.

### DESCRIPTION

The following description of certain examples should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

### A. Exemplary Hydraulic Actuator Assembly

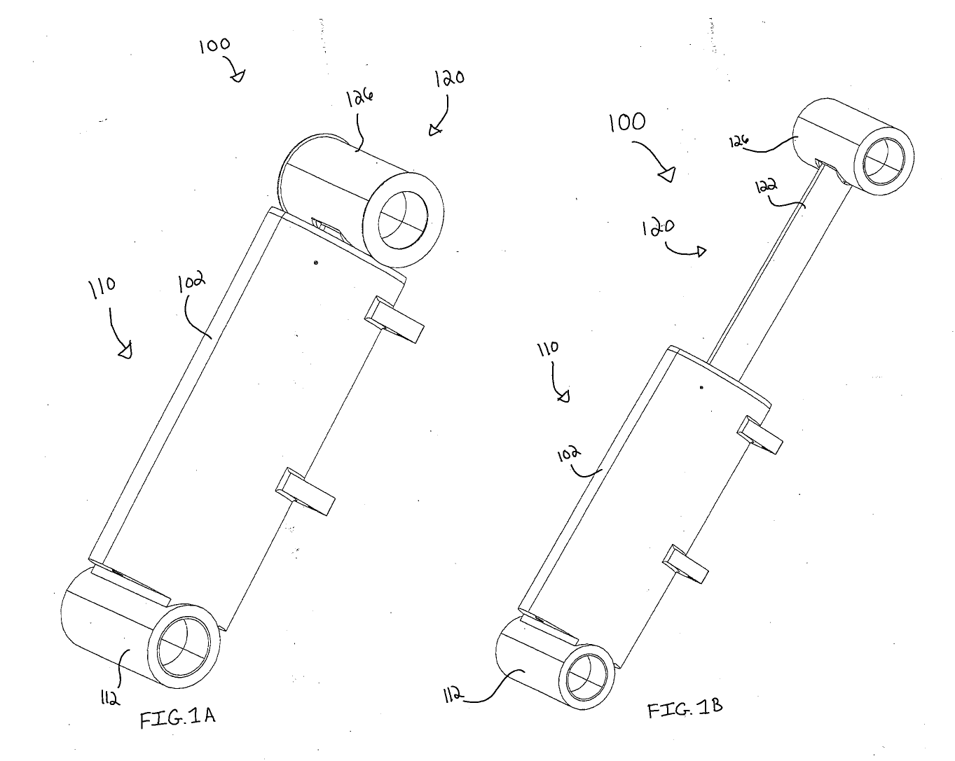

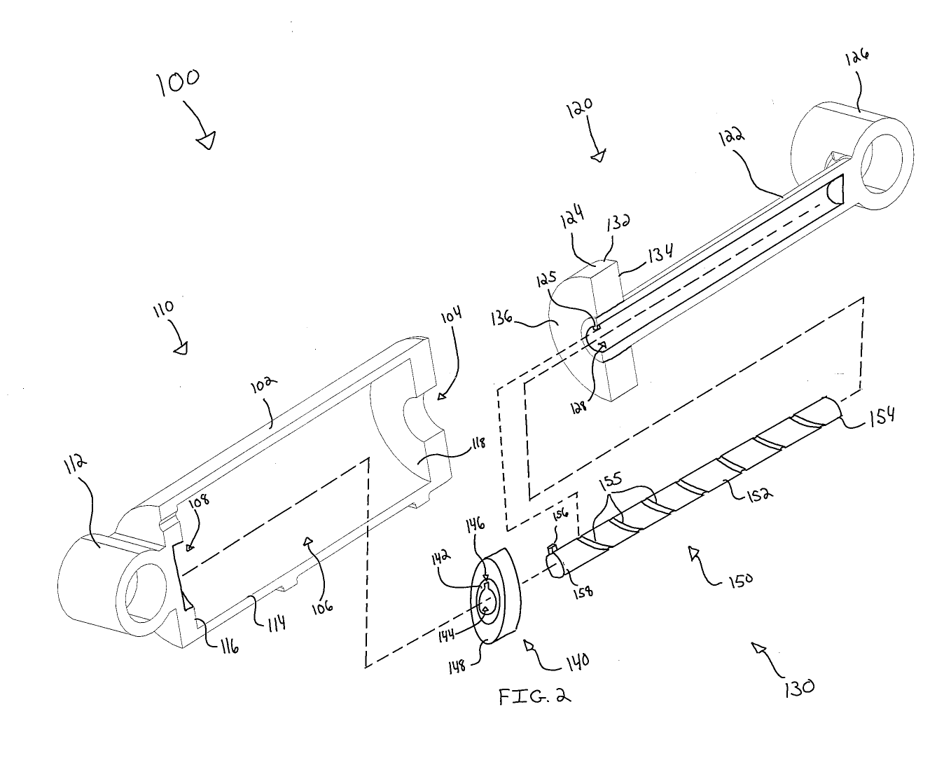

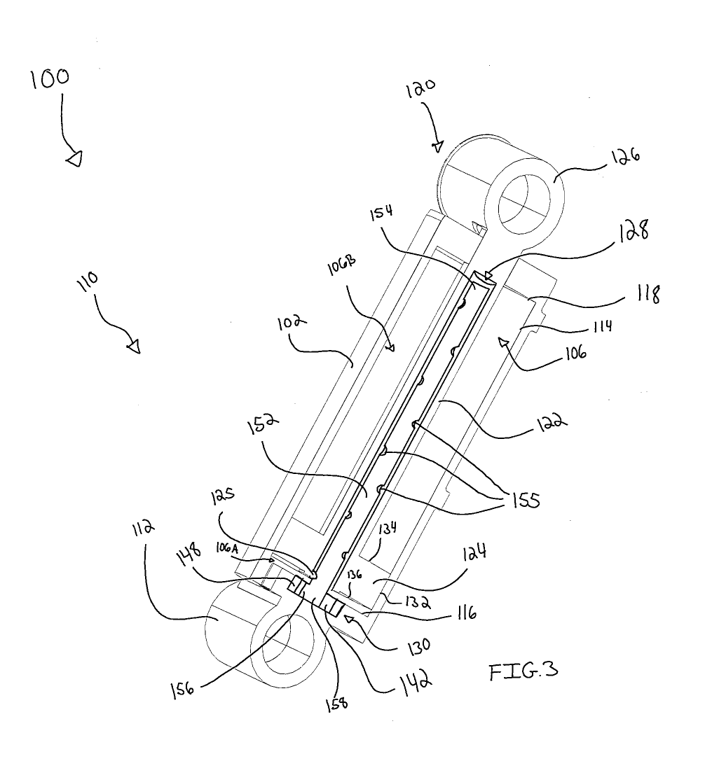

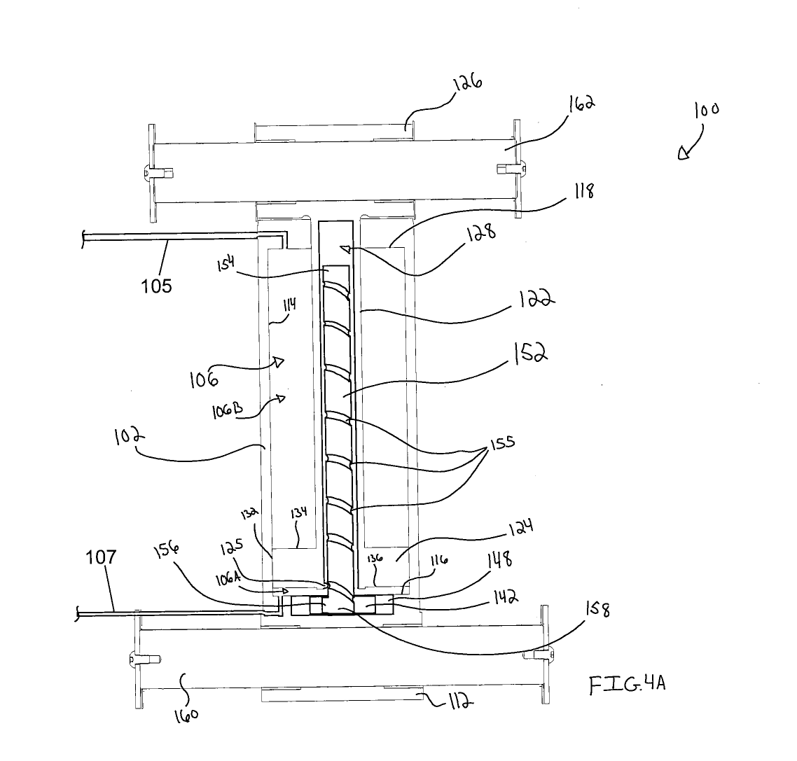

FIGS. 1-4C show an exemplary hydraulic actuator assembly (100) that may be readily incorporated into a variety of vehicle lift assemblies. As best shown in FIG. 2, hydraulic actuator assembly (100) includes a cylinder assembly (110), a linear actuating assembly (120), and a linear displacement measuring assembly (130). As will be described in greater detail below, linear actuating assembly (120) may move relative to cylinder assembly (110) from a fully withdrawn position, as shown in FIG. 1A, to a fully extended position, as shown in FIG. 1B. Additionally, linear actuating assembly (120) may move to any number of positions between the fully withdrawn and the fully extended position. Therefore, movement of linear actuating assembly (120) may be utilized in order to actuate a vehicle lift assembly in order to raise or lower a vehicle to a desired height. Such vehicle lift assemblies may include a scissor lift assembly, a carriage style lift assembly, an in-ground lift assembly, an above-ground lift assembly, or any other suitable lift assembly that would be apparent to one having ordinary skill in the art.

Cylinder assembly (110) includes a hydraulic cylinder (102) and an attachment feature (112). While in the current example, hydraulic cylinder (102) and attachment feature (112) are unitarily connected, it should be understood that hydraulic cylinder (102) and attachment feature (112) may be fixedly coupled with any other suitable means known to a person having ordinary skill in the art in view of the teachings herein. For example, hydraulic cylinder (102) and attachment feature (112) may be fixedly coupled with a plurality of nuts and bolts.

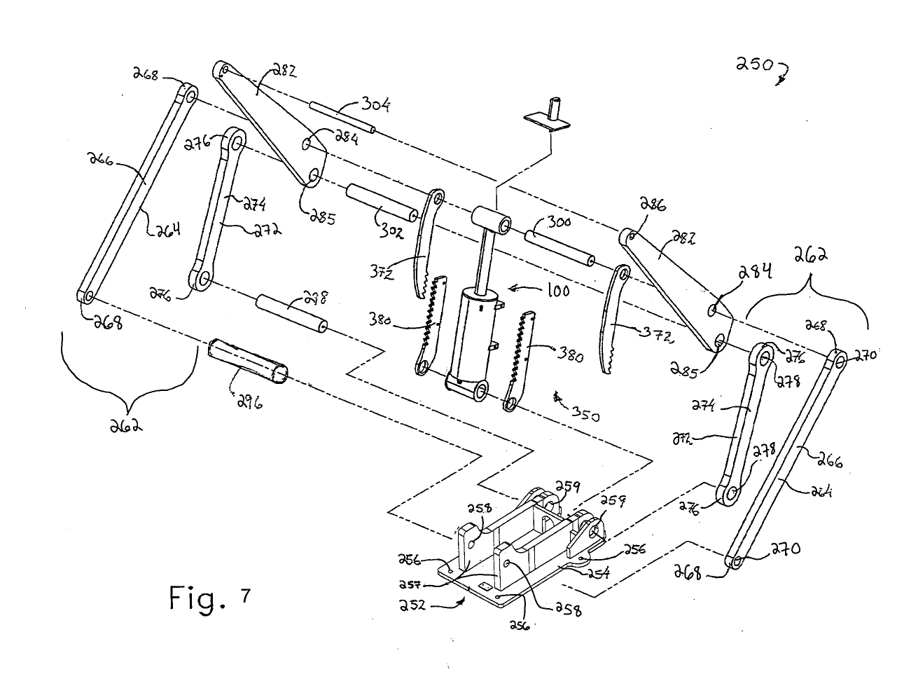

Attachment feature (112) is located at the bottom of hydraulic cylinder (102) in order to couple cylinder assembly (110) to a portion of a vehicle lift assembly, as will be described in greater detail below. In the current example, attachment feature (112) is configured to receive a pin (298) (see FIG. 7) in order to attach hydraulic cylinder (102) to a portion of a vehicle lift assembly. Therefore, attachment feature (112) may allow hydraulic actuator assembly (100) to rotate about an axis defined by pin (298). In other words, hydraulic cylinder (102) may be rotatably coupled to a portion of a vehicle lift assembly (e.g., a lift assembly (250) as shown in FIG. 5) via attachment feature (112).

However, it should be understood that rotational capabilities of attachment feature (112) are merely optional. Some vehicle lift assemblies do not require rotation of hydraulic cylinder (102) in order to raise or lower a vehicle. For example, hydraulic cylinder (102) may alternatively be slidably coupled to a portion of vehicle lift assembly. Hydraulic cylinder (102) may alternatively be fixedly coupled to a portion of a vehicle lift assembly (e.g., a lift assembly (250) as shown in FIG. 5). Any suitable attachment feature known by a person having ordinary skill in the art in view of the teachings herein may be employed.

Turning to FIG. 2, hydraulic cylinder (102) includes an interior base end (116), an interior annular wall (114), and an interior head end (118); all of which collectively define a cavity (106). Head end (118) further defines a tunnel (104) extending from cavity (106) to an exterior of hydraulic cylinder (102). Tunnel (104) is dimensioned to slidably house a rod (122) of linear actuating assembly (120) while cavity (106) is dimensioned to slidably house a plunger (124) of linear actuating assembly (120). Plunger (124) and rod (122) are coupled with each other such that plunger (124) and rod (122) slide relative to tunnel (104) and cavity (106) together.

Hydraulic cylinder (102) also has a fluid channel (107) associated with the base end (116) and a fluid channel (105) associated with the head end (118). Each fluid channel (105, 107) is in fluid communication with a chamber (106A, 106B) of cavity (106), respectively. Chamber (106A) is defined by interior base end (116), interior annular wall (114), and a radial face (136) of plunger (124). Chamber (106B) is defined by interior head end (118), interior annular wall (114), and a radial face (134) of plunger (124). It should be understood that because plunger (124) is slidable within cavity (106), chambers (106A, 106B) are capable of changing volume as plunger (124) actuates within cavity (106).

Each fluid channel (105, 107) may fill respective chamber (106A, 106B) with hydraulic fluid. Tunnel (104) and rod (122) may fluidly isolate chamber (106B) from the exterior of hydraulic cylinder (102) by using a seal gland or in any other suitable manner known to the art in view of the teachings herein. As will be described in greater detail below, fluid channels (105, 107) may help actuate plunger (124) within cavity (106).

Base end (116) further defines a rotary sensor mount (108) dimensioned to house a rotary sensor (140). Rotary sensor mount (108) is capable of fixing a portion of rotary sensor to hydraulic cylinder (102). While in the current example, rotary sensor mount (108) is a recess defined by base end (116), bolts, nuts, threaded rods, or any other suitable structures may be utilized to fix a portion of rotary sensor (114) to hydraulic cylinder (102).

Linear actuating assembly (120) includes rod (122) having one end fixed to plunger (124) and another end fixed to an attachment feature (126). Rod (122) defines channel (128). Channel (128) extends from the portion of rod (122) that is fixed to plunger (124) toward the portion of rod (122) fixed to attachment feature (126). Rod (122) also has a pin (125) located at the portion of rod (122) fixed to plunger (124). As will be described in more detail below, channel (128) and pin (125) are dimensioned to interact with linear displacement measuring assembly (130) to measure the distance linear actuating assembly (120) actuates relative to cylinder assembly (110). This information may be utilized to determine the individual height of each hydraulic actuator assembly (100) in a vehicle lift system. A vehicle lift system may utilize this data in order to level a vehicle lift system, to limit or manage movement of linear actuating assembly (120), and for other purposes as will occur to those skilled in the art.

While in the current example, rod (122) and attachment feature (126) are unitarily connected, it should be understood that rod (122) and attachment feature (126) may be fixedly coupled with any other suitable means known to a person having ordinary skill in the art in view of the teachings herein. For example, rod (122) and attachment feature (126) may be fixedly coupled with a plurality of nuts and bolts.

Attachment feature (126) is located at the top of rod (122) in order to couple rod (122) to a portion of a vehicle lift assembly, as will be described in greater detail below. In the current example, attachment feature (126) is configured to receive a pin (300) in order to attach rod (122) to a portion of a vehicle lift assembly. Therefore, attachment feature (126) may allow hydraulic actuator assembly (100) to rotate about an axis defined by pin (300). In other words, rod (122) may be rotatably coupled to a portion of vehicle lift assembly via attachment feature (126).

However, it should be understood that rotational capabilities of attachment feature (126) are merely optional. Some vehicle lift assemblies do not require rotation of rod (122) in order to raise or lower a vehicle. For example, rod (122) may be fixedly coupled to a portion of a vehicle lift assembly, or any other suitable attachment feature known by a person having ordinary skill in the art in view of the teachings herein may be employed.

As mentioned above, rod (122) is slidably housed within tunnel (104) of hydraulic cylinder (102). Plunger (124) may be fixed to rod (122) by threads, bolts, or nuts, or any other structures known to one having ordinary skill in the art in view of the teachings herein. As mentioned above, plunger (124) is slidably housed within cavity (106). Plunger (124) is also positioned and dimensioned such that a circumferential face (132) of plunger (124) makes contact with interior annular wall (114). Circumferential face (132) of plunger (124) may be machined with grooves configured to fit elastomeric or metal seals and bearing elements. Plunger (124) is configured to separate cavity (106) into two fluidly isolated chambers (106A, 106B). Therefore, first chamber (106A) and second chamber (106B) defined by cavity (106) and plunger (124) may fill or empty with fluid via fluid channels (105, 107) in order to actuate plunger (124).

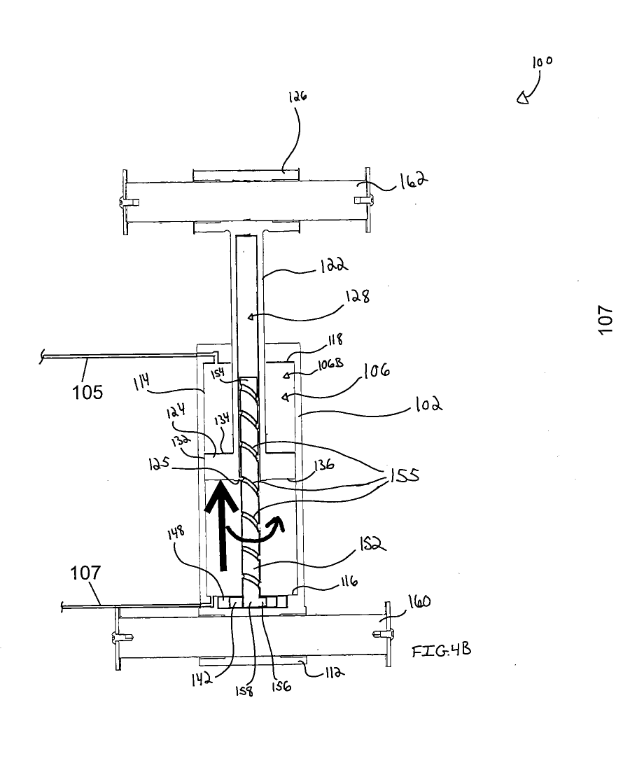

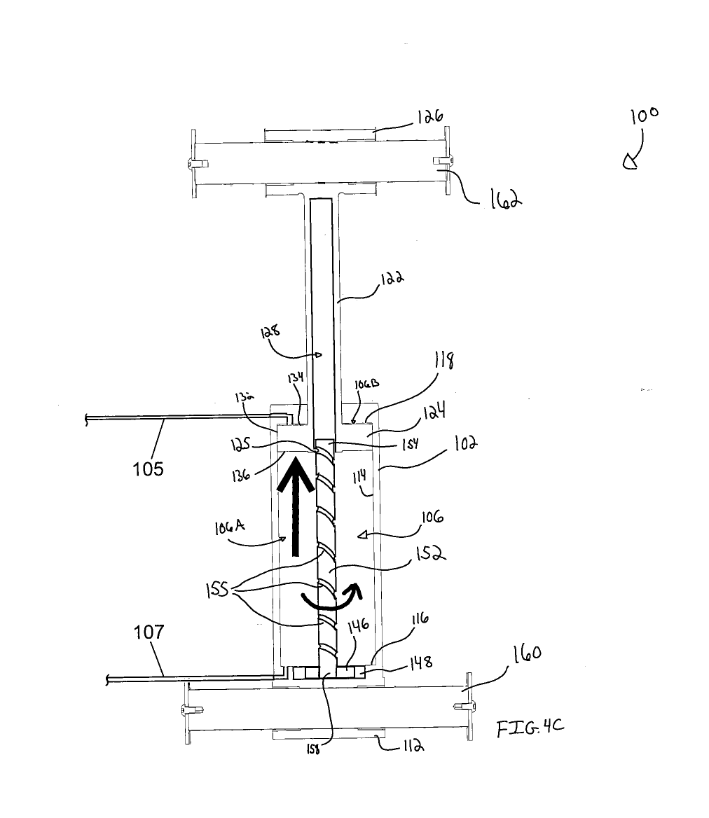

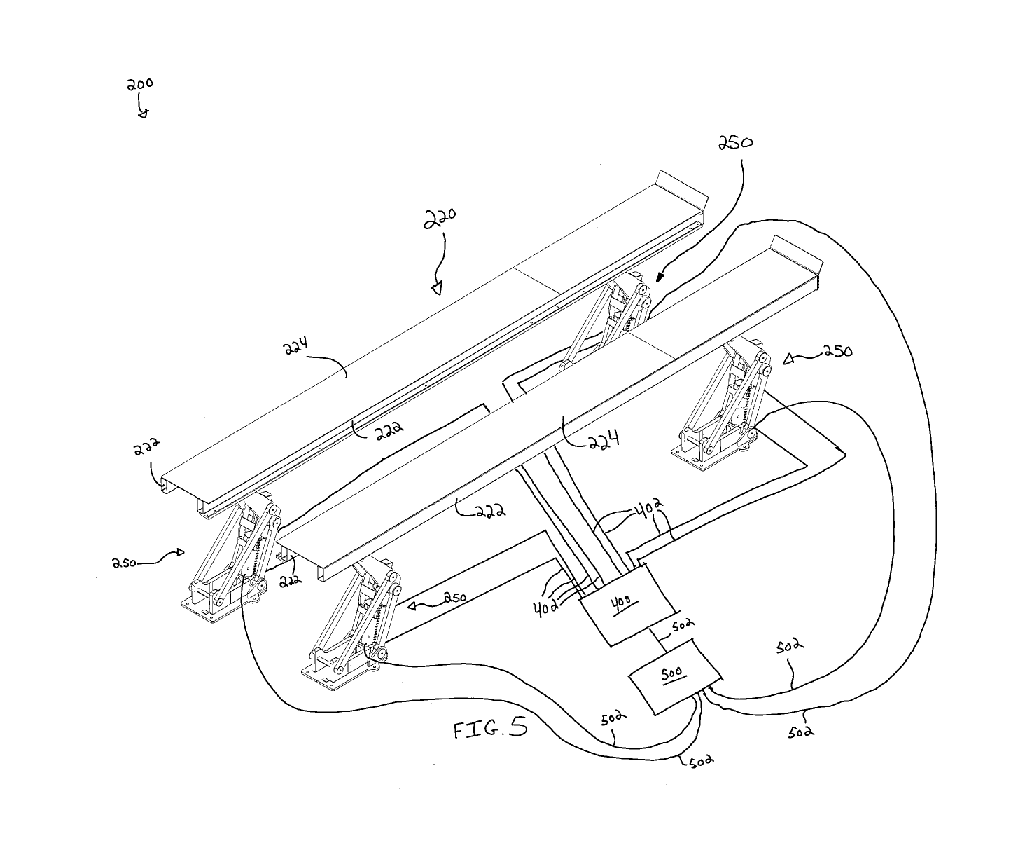

As mentioned above, hydraulic cylinder (102) has two fluid channels (105, 107) on opposite ends of hydraulic cylinder (102). Additionally, as mentioned above, first fluid chamber (106A) and second fluid chamber (106B) are in fluid isolation from one another. First fluid channel (107) may be in fluid communication with first chamber (106A) while second fluid channel (105) may be in fluid communication with second chamber (106B). One fluid channel (105, 107) may be in communication with a fluid source such as a pump while the other fluid channel (105, 107) may be in fluid communication with another fluid source such as a reservoir. Fluid sources in fluid communication with channels (105, 107) may fill first chamber (106A) with hydraulic fluid while emptying second chamber (106B) with hydraulic fluid. Because first chamber (106A) and second chamber (106B) are in fluid isolation, plunger (124) and the rest of linear actuating assembly (120) may actuate, similar to that shown in FIGS. 1A-1B and FIGS. 4A-4C, due to the change in volume of chambers (106A, 106B).

It should be understood that there may be additional, external forces acting on hydraulic actuator assembly (100) which the pressure in first fluid chamber (106A) or second fluid chamber (106B) may need to overcome in order to actuate linear actuating assembly (120). For instance, if attachment feature (126) is connected to a portion of a vehicle lift assembly that is supporting a portion of a vehicle, the force provided by the pressure in first fluid chamber (106A) acting on radial face (136) may need to overcome the load provided from supporting a portion of the vehicle.

For example, as shown in FIGS. 1A-1B and FIGS. 4A-4C, if hydraulic fluid is filled within first chamber (106A) while hydraulic fluid is emptied from second chamber (106B), an upward force is generated on plunger (124), which actuates linear actuating assembly (120) in an upward direction with respect to hydraulic cylinder (102). In the opposite way, if hydraulic fluid is emptied from first chamber (106A) while hydraulic fluid is being filled within the second chamber (106B), a downward force may be generated on plunger (124), which actuates linear actuating assembly (120) in a downward direction with respect to hydraulic cylinder (102).

Linear displacement measuring assembly (130) includes a rotation sensor (140) and a rotational actuating assembly (150). Rotation sensor (140) includes a rotating element (142) rotatably housed within a static element (148). Static element (148) is fixedly housed within rotary sensor mount (108) of hydraulic cylinder (102). Static element (148) may not rotate or actuate relative to hydraulic cylinder (102). Rotating element (142) defines an aperture (144) and a keyed hole (146). Static element (148) is configured to measure the rotational displacement of rotating element (142). As will be described in greater detail below, rotation sensor (140) is in electrical communication with a circuit board of a vehicle lift assembly or related sensing and/or control circuitry. The vehicle lift assembly may utilize the rotational displacement of rotating element (142) relative to static element (148) in order to monitor the positions of each of any number of hydraulic actuator assemblies (100) utilized in the vehicle lift assembly, using the rotational displacement to calculate the linear displacement of each hydraulic actuator assembly (100), and using that calculated linear displacement in a feedback control loop to manage the operation of the collection of hydraulic actuator assemblies (100).

Rotational actuating assembly (150) includes a rotating shaft (152) and a keyed member (156). Rotating shaft (152) extends from a free end (154) to a coupling end (158). Coupling end (158) is housed within aperture (144) of rotation sensor (140), while keyed member (156) is housed with keyed hole (146). Coupling end (158) may be dimensioned for an interference fit with aperture (144) such that rotating shaft (152) may not actuate in the vertical direction relative to rotating element (142). For example, free end (154) may be dimensioned small enough to fit within aperture (144) while coupling end (158) may be dimensioned for an interference fit. Rotating shaft (152) may be inserted through aperture (144) via free end (154) until coupling end (158) develops an interference fit with aperture (144). Of course, rotating shaft (152) may be fixed in a vertical direction relative to rotating element (142) in any other suitable manner as would be apparent to one having ordinary skill in the art in view of the teachings herein. For example, coupling end (158) may be fixed to a bearing attached to base end (116) of cylinder assembly (110).

Rotating shaft (152) also defines a helical slot (155) extending from coupling end (158) towards free end (154). Helical slot (155) is dimensioned to receive pin (125). As seen in FIGS. 4A-4C, as hydraulic fluid enters chamber (106A) and exits chamber (106B), linear actuating assembly (120) moves from a withdrawn position to an extended position. Additionally, pin (125) travels along helical slot (155), providing a camming effect to rotate rotating shaft (152) about the axis defined by movement of linear actuating assembly (120). As described above, keyed member (156) and coupling end (158) are rotationally fixed to rotating element (142) of rotation sensor (140) via keyed hole (146) and aperture (144). Therefore, as pin (125) rotates rotating shaft (152) via movement of linear actuating assembly (120), coupling end (158) and keyed member (156) rotate rotating element (142) relative to static element (148) of rotation sensor (140). Static element (148) may measure the rotational displacement of rotating element (142). Helical slot (155) may be shaped and dimensioned such that rotation of rotating shaft (152) directly correlates to linear displacement of linear actuating assembly (120) along rotating shaft (152). In other words, linear displacement measuring assembly (130) may measure the linear displacement of linear actuating assembly (120) relative to cylinder assembly (110) by measuring the rotation of rotating shaft (152) caused by camming action of pin (125).

It should be understood that since rotation of rotating shaft (152) relative to linear actuating assembly (120) is used to measure linear displacement of linear actuating assembly (120), there should be no accidental rotation about the axis defined by movement of linear actuating assembly (120) of rotating shaft (152) relative to linear actuating assembly (120). Accidental rotation of rotating shaft (152) relative to linear actuating assembly (120) could give a false reading of linear displacement along the axis defined by movement of linear actuating assembly (120). Therefore, attachment features (112, 126) need to rotationally fix cylinder assembly (110) and linear actuating assembly (120) relative to one another, along the axis defined by movement of linear actuating assembly (120), to prevent false readings. While in the current example, attachment features (112, 126) include pin eyes, any other suitable attachment features may be used as would be apparent to one having ordinary skill in the art.

Having linear displacement measuring assembly (130), or at least a portion of linear displacement measuring assembly (130) stored within cylinder assembly (110) and linear actuating assembly (120), may provide benefits of protecting linear displacement measuring assembly (130) from external moving parts, dust, and debris. Additionally, linear displacement measuring assembly (130) may be rigid for durability, as compared to known string potentiometers currently used.

### B. First Alternative Hydraulic Actuator Assembly

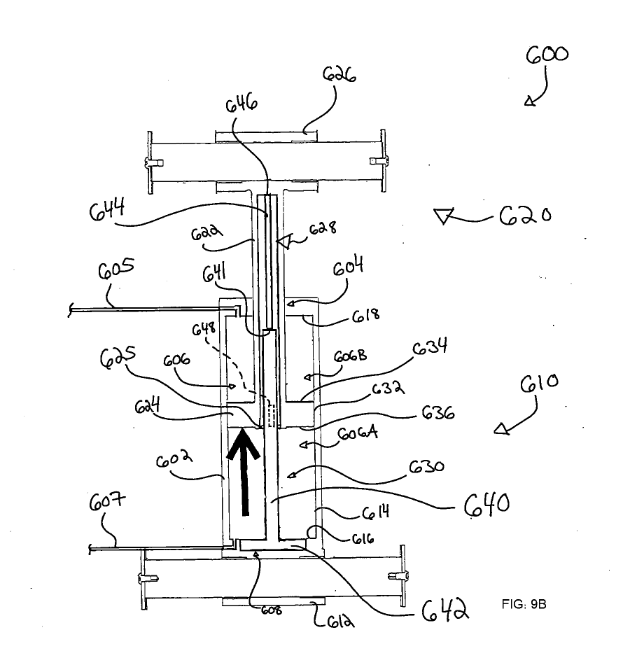

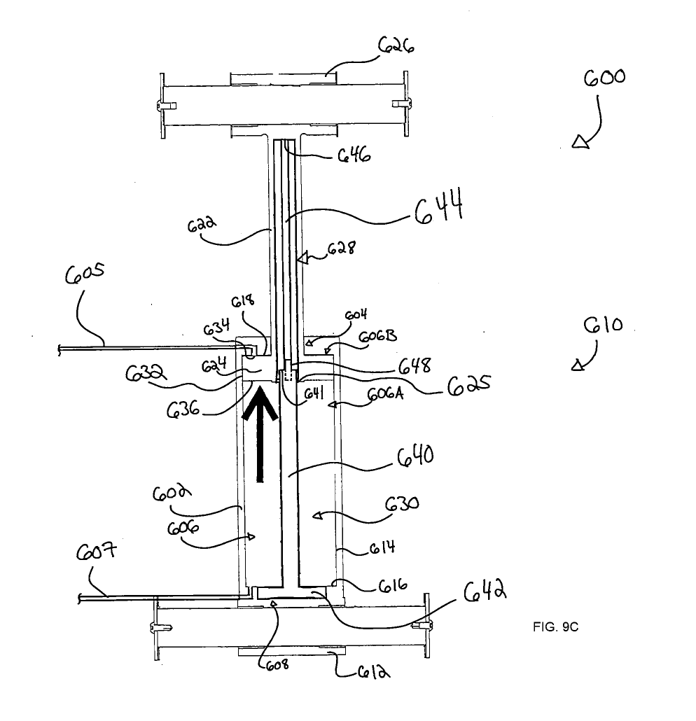

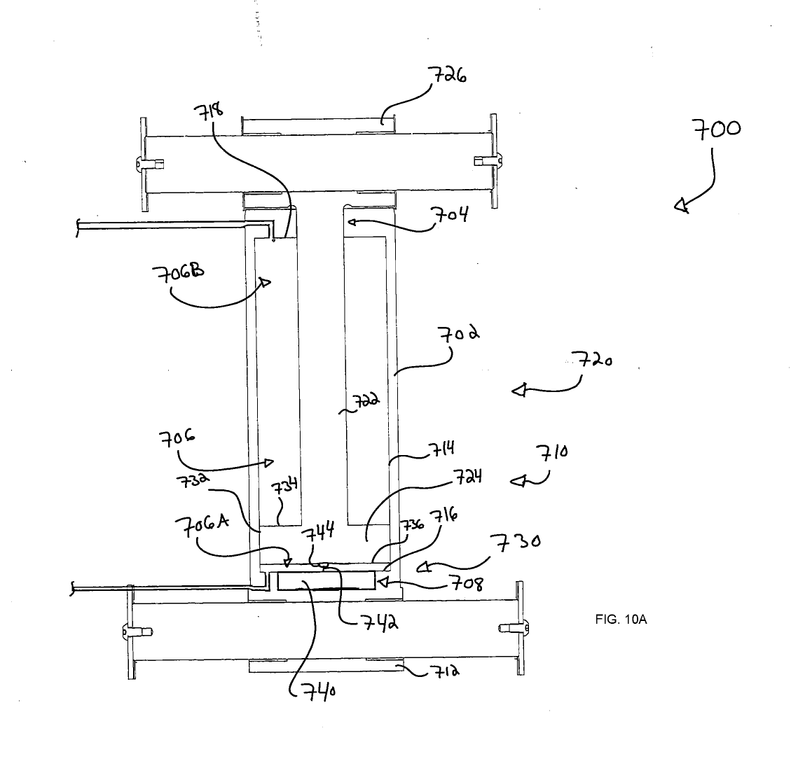

FIGS. 9A-9C show an alternative exemplary hydraulic actuator assembly (600) that may be readily incorporated into a variety of vehicle lift assemblies in place of hydraulic actuator assembly (100) described above. Hydraulic actuator assembly (600) includes a cylinder assembly (610), a linear actuating assembly (620), and a linear transducer assembly (630).

Cylinder assembly (610) and linear actuating assembly (620) may be substantially similar to cylinder assembly (110) and linear actuating assembly (120) described above, respectively, with differences described below. Therefore, linear actuating assembly (620) may move relative to cylinder assembly (610) from a fully withdrawn position, as shown in FIG. 9A, to a fully extended position, as shown in FIG. 9C. Additionally, linear actuating assembly (620) may move to any number of positions between the fully withdrawn and fully extended position. Therefore, movement of linear actuating assembly (620) may actuate a vehicle lift assembly to raise or lower a vehicle to a desired height, similar to the process described above for hydraulic actuator assembly (100). Such vehicle lift assembly may include a scissor lift assembly, a carriage-style lift assembly, an in-ground lift assembly, an above-ground lift assembly, or any other suitable lift assembly that would be apparent to those having ordinary skill in the art in view of the teachings herein.

Cylinder assembly (610) includes a hydraulic cylinder (602) and an attachment feature (612), which are substantially similar to hydraulic cylinder (102) and attachment feature (112) described above, respectively. Hydraulic cylinder (602) includes an interior base end (616), an interior annular wall (614), and an interior head end (618), which are substantially similar to interior base end (116), interior annular wall (114), and interior head end (118) described above, respectively. Interior base end (616), interior annular wall (614), and interior head end (618) collectively define cavity (606).

Head end (618) defines tunnel (604) extending from cavity (606) to an exterior of hydraulic cylinder (602). Tunnel (604) is dimensioned to slidably house a rod (622) of linear actuating assembly (620) while cavity (606) is dimensioned to slidably house a plunger (624) of linear actuating assembly (620). Plunger (624) and rod (622) are substantially similar to plunger (124) and rod (122) described above, respectively, with differences described below. Therefore, plunger (624) and rod (622) are coupled with each other such that plunger (624) and rod (622) slide together relative to tunnel (604) and cavity (606).

Hydraulic cylinder (602) also has fluid channels (605, 607), which are substantially similar to fluid channels (105, 107) described above, respectively. Therefore, each fluid channel (605, 607) is in fluid communication with a chamber (606A, 606B). Chambers (606A, 606B) are substantially similar to chambers (106A, 106B) described above. Chamber (606A) is defined by interior base end (616), interior annular wall (614), and a radial face (636) of plunger (624). Chamber (606B) is defined by interior head end (618), interior annular wall (615), and a radial face (634) of plunger (624). It should be understood that because plunger (624) is slidable within cavity (606), chambers (606A, 606B) are capable of changing in volume as plunger (624) actuates within cavity (606).

Each fluid channel (605, 607) may fill respective chamber (606A, 606B) with hydraulic fluid. Tunnel (604) and rod (622) may fluidly isolate chamber (606B) from the exterior of hydraulic cylinder (602) by using a seal gland or in any other suitable manner known to the art in view of the teachings herein. As will be described in greater detail herein, fluid channels (605, 607) may help actuate plunger (624) within cavity (606).

Base end (616) defines a sensor mount (608) dimensioned to house a portion of linear transducer assembly (630). Sensor mount (608) is capable of fixing a portion of linear transducer assembly (630). While in the current example, sensor mount (608) is a recess defined by base end (616), bolts, nuts, threaded rods, or any other suitable structures may be utilized to fix a portion of linear transducer assembly (630) to hydraulic cylinder (602).

Linear actuating assembly (620) includes rod (622) having one end fixed to plunger (624) and another end fixed to an attachment feature (626). Rod (622) defines a channel (628). Channel (628) extends from a portion of rod (622) that is fixed to plunger (624) toward the portion of rod (622) fixed to attachment feature (626). A seal (625) may be located at the open end of channel (628) or any other suitable location within channel (628) as would be apparent to one having ordinary skill in the art in view of the teachings herein. As will be described in greater detail below, seal (625) may prevent hydraulic fluid from entering certain portions of channel (628). However, it should be understood that seal (625) is merely optional.

Attachment feature (626) may be substantially similar to attachment feature (126) described above, with differences described below. Attachment feature (626) may rotatably couple rod (622) to a portion of vehicle lift assembly. However, it should be understood that rotatably coupling rod (622) to a vehicle lift assembly is merely optional. For instance, rod (622) may couple with vehicle lift assembly in any suitable manner that would be apparent to one having ordinary skill in the art in view of the teachings herein.

As mentioned above, plunger (624) is slidably housed within cavity (606). Plunger (624) makes contact with interior annular wall (614). Circumferential face (632) of plunger (624) may be machined with grooves configured to fit elastomeric or metal seals and bearing elements. Therefore, plunger (624) is configured to separate cavity (606) into two fluidly isolated chambers (606A, 606B).

Linear transducer assembly (630) includes a coil assembly (640) fixed within hydraulic cylinder (602) via a base (642), and an actuating transducer member (644) fixed to rod (622) at the closed end of channel (628) via actuating coupling portion (646). Actuating coupling portion (646) may include any suitable coupling means known to one having ordinary skill in the art in view of the teachings herein. For example, actuating coupling portion (646) may include welding, an interference fit, bolts, and the like as will occur to those having ordinary skill in the art in view of this disclosure.

Additionally, actuating transducer member (644) is slidably housed within coil assembly (640) via an opening (641) defined at the open end of coil assembly (640). Actuating transducer member (644) also includes a core member (648) located at the end of actuating transducer member (644) opposite actuating coupling portion (646). Of course, coil member (648) may be located at any other suitable location along actuating transducer member (644) as would occur to one having ordinary skill in the art in view of the teaching here.

Coil assembly (640), actuating transducer member (644), and coil member (648) may function like a linear variable differential transformer. Coil assembly (640) is able to determine the location of core member (648) within opening (641) of coil assembly (640). Because core member (648) is fixedly attached to actuating transducer member (644), which is also fixedly attached to linear actuating assembly (620); and coil assembly (640) is fixedly attached within cylinder assembly (610); coil member (640) is capable of measuring the displacement of linear actuating assembly (620) relative to cylinder assembly (610) based on the location of core member (648). In other words, coil assembly (640) may determine the location of linear actuating assembly (620) relative to cylinder assembly (610) by locating core member (648).

As mentioned above, seal (625) may prevent hydraulic fluid from entering certain portions of channel (628). In particular, seal (625) may be placed within channel (628) to prevent hydraulic fluid from entering within opening (641) of coil assembly (640).

Unlike linear displacement measuring assembly (130) descried above, linear transducer assembly (630) may correctly measure the distance between linear actuating assembly (620) and cylinder assembly (610) even if there is accidental rotation of linear actuating assembly (620) relative to cylinder assembly (610).

Having at least a portion of linear transducer assembly (630) stored within cylinder assembly (610) and linear actuating assembly (620) may provide benefits of protecting linear displacement measuring assembly (630) from external moving parts, dust, and debris. Additionally, linear displacement measuring assembly (630) may be rigid for durability, as compared to known string potentiometers currently used.

As will be described in greater detail below, coil assembly (640) is in electrical communication with a circuit board of a vehicle lift assembly or related sensing and/or control circuitry. The vehicle lift assembly may utilize the displacement of core member (648) within coil assembly (640) in order to monitor the positions of each of any number of hydraulic actuator assemblies (600) utilized in the vehicle lift assembly, using the displacement to calculate the linear displacement of each hydraulic actuator assembly (600), and using that calculated linear displacement in a feedback control loop to manage the operation of the collection of hydraulic actuator assemblies (600).

### C. Second Alternative Hydraulic Actuator Assembly

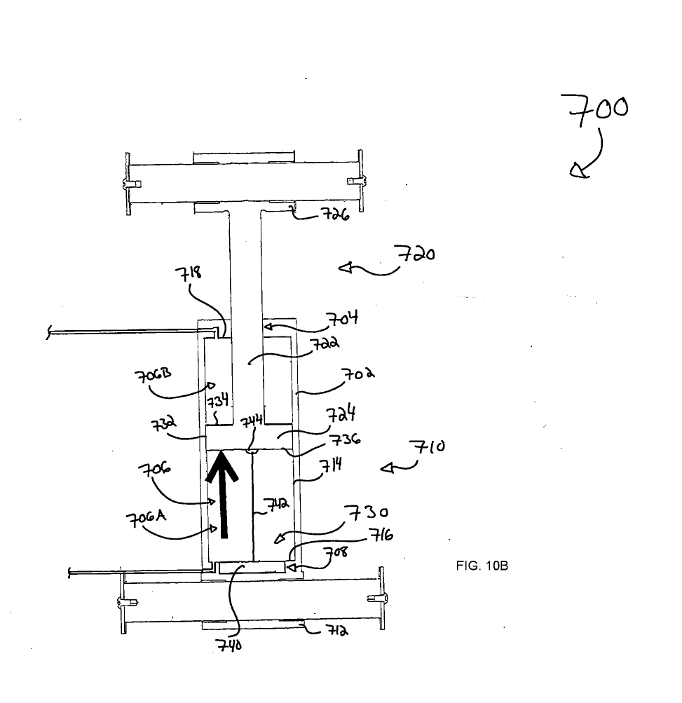

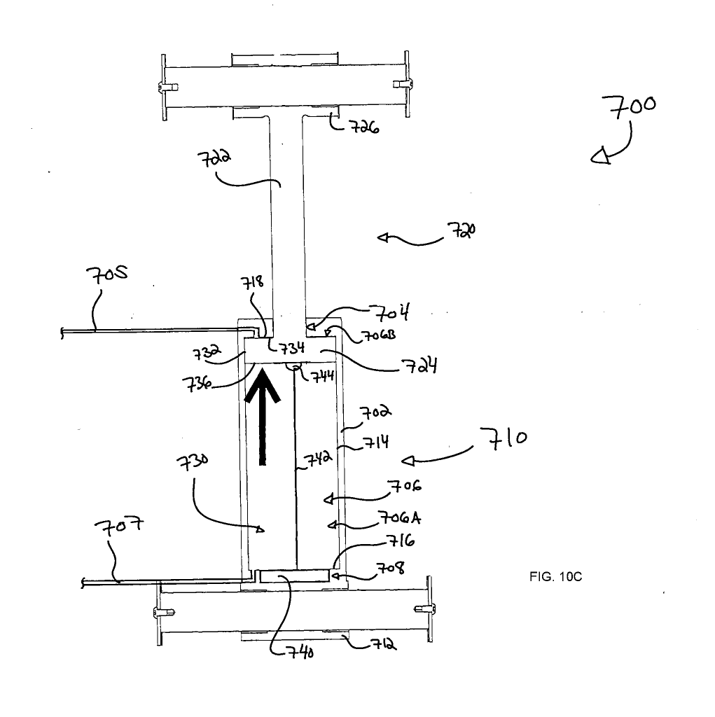

FIGS. 10A-10C show an alternative exemplary hydraulic actuator assembly (700) that may be readily incorporated into a variety of vehicle lift assemblies. Therefore, hydraulic actuator assembly (700) may be used in substitution for hydraulic actuator assembly (100, 600) described above. Hydraulic actuator assembly (700) includes a cylinder assembly (710), a linear actuating assembly (720), and a linear transducer assembly (730).

Cylinder assembly (710) and linear actuating assembly (720) may be substantially similar to cylinder assembly (110) and linear actuating assembly (120) described above, respectively, with differences described below. Therefore, linear actuating assembly (720) may move relative to cylinder assembly (710) from a fully withdrawn position, as shown in FIG. 10A, through a partially extended position, as shown in FIG. 10B, to a fully extended position, as shown in FIG. 10C. Additionally, linear actuating assembly (720) may move to any number of positions between the fully withdrawn and fully extended position. Therefore, movement of linear actuating assembly (720) may be used to actuate a vehicle lift assembly to raise or lower a vehicle to a desired height, similar to the process described above for hydraulic actuator assembly (100). Such vehicle lift assembly may include a scissor lift assembly, a carriage-style lift assembly, an in-ground lift assembly, an above-ground lift assembly, or any other suitable lift assembly that would be apparent to one having ordinary skill in the art in view of the teachings herein.

Cylinder assembly (710) includes a hydraulic cylinder (702) and an attachment feature (712), which are substantially similar to hydraulic cylinder (102) and attachment feature (112) described above, respectively. Therefore, hydraulic cylinder (702) includes an interior base end (716), an interior annular wall (714), and an interior head end (718), which are substantially similar to interior base end (116), interior annular wall (114), and interior head end (118) described above, respectively. Interior base end (716), interior annular wall (714), and interior head end (718) collectively define cavity (706).

Head end (718) defines tunnel (704) extending from cavity (706) to an exterior of hydraulic cylinder (702). Tunnel (704) is dimensioned to slidably house a rod (722) of linear actuating assembly (720), while cavity (706) is dimensioned to slidably house a plunger (724) of linear actuating assembly (720). Plunger (724) and rod (722) are substantially similar to plunger (124) and rod (122) described above, respectively, with differences described below. Therefore, plunger (724) and rod (722) are coupled with each other such that plunger (724) and rod (722) slide relative to tunnel (704) and cavity (706) together.

Hydraulic cylinder (702) also has fluid channels (705, 707), which are substantially similar to fluid channels (105, 107) described above, respectively such that each fluid channel (705, 707) is in fluid communication with a chamber (706A, 706B). Chambers (706A, 706B) are substantially similar to chambers (106A, 106B) described above. Therefore, chamber (706A) is defined by interior base end (716), interior annular wall (714), and a radial face (736) of plunger (724). Chamber (706B) is defined by interior head end (718), interior annular wall (715), and a radial face (734) of plunger (724). It should be understood that because plunger (724) is slidable within cavity (706), chambers (706A, 706B) are capable of changing volume as plunger (724) actuates within cavity (706).

Each fluid channel (705, 707) may fill respective chamber (706A, 706B) with hydraulic fluid. Tunnel (704) and rod (722) may fluidly isolate chamber (706B) from the exterior of hydraulic cylinder (702) by using a seal gland or in any other suitable manner known to the art in view of the teachings herein. As will be described in greater detail below, fluid channels (705, 707) may help actuate plunger (724) within cavity (706).

Base end (716) defines a sensor mount (708) dimensioned to house a portion of linear string potentiometer assembly (730). Sensor mount (708) is capable of fixing a portion of linear string potentiometer assembly (730), and in the current example, sensor mount (708) is a recess defined by base end (716). Bolts, nuts, threaded rods, or any other suitable structures may be utilized to fix a portion of linear string potentiometer assembly (730) to hydraulic cylinder (702).

Linear actuating assembly (720) includes rod (722) having one end fixed to plunger (724) and another end fixed to an attachment feature (726). Attachment feature (726) may be substantially similar to attachment feature (126) described above, with differences described below. Therefore, attachment feature (726) may allow rod (722) to rotatably couple to a portion of vehicle lift assembly. However, it should be understood that rotatably coupling rod (722) to a vehicle lift assembly is merely optional.

As mentioned above, plunger (724) is slidably housed within cavity (706). Plunger (724) makes contact with interior annular wall (714). Circumferential face (732) of plunger (724) may be machined with grooves configured to fit elastomeric or metal seals and bearing elements. Therefore, plunger (724) is configured to separate cavity (706) into two fluidly isolated chambers (706A, 706B).

Linear string potentiometer assembly (730) includes a sensor assembly (740) fixed to cylinder assembly (710) via sensor mount (708), a measuring cable (742), and a coupling feature (744). A portion of measuring cable (742) is housed within sensor assembly (740). Measuring cable (742) is capable of extending and retracting relative to sensor assembly (740). Coupling feature (744) fixes an end of measuring cable (742) to radial face (736) of plunger (724). Therefore, measuring cable (742) extends and retracts relative to sensor assembly (740) in accordance with linear actuating assembly (720) actuating within hydraulic cylinder (702).

Sensor assembly (740) and measuring cable (742) are configured to act as standard string potentiometer. Therefore, as measuring cable (742) extends and retracts relative to sensor assembly (740), sensor assembly (740) may measure the distance defined by the portion of measuring cable (742) extending from sensor assembly (740). Because measuring cable (742) is fixed to plunger (724) at one end, and sensor assembly (740) is fixed to cylinder assembly (710), measuring cable (742) and sensor assembly (740) are configured to measure the displacement of linear actuating assembly (720) relative to cylinder assembly (710).

Having at least a portion of linear string potentiometer assembly (730) stored within cylinder assembly (710) and linear actuating assembly (720) may provide benefits of protecting linear string potentiometer assembly (730) from external moving parts, dust, and debris.

### D. Exemplary Vehicle Lift Assembly

FIG. 5 shows a perspective view of vehicle lift system (200) in a raised position. Vehicle lift system (200) comprises two runways (220), four lift assemblies (250), a control circuit (500), and a pump (400). Runways (220) are generally rectangular in shape, extending from one lift assembly (250) to another. Each runway (220) comprises two longitudinally extending side rails (222) and a relatively flat top plate (224). Side rails (222) are comprised of any suitable rigid material, such as steel, iron, aluminum, composites, etc. Although side rails (222) are shown as having a generally rectangular construction, it should be understood that side rails (222) may have any suitable cross-sectional geometry such as square, round, I-shaped, L- shaped, Z-shaped, or the like.

Top plate (224) is secured to the top of side rails (222) by any suitable means such as welding, mechanical fastening, adhesive boding, etc. In the present example, top plate (224) is comprised of a thin sheet of a rigid material such as steel, iron, aluminum, composite, or the like. Top plate (224) is configured to support the load of a vehicle resting on runways (220). The load of a vehicle is also distributed by top plate (224) to runways (220), which provide additional structural rigidity.

Each runway (220) is positioned relative to the other a transverse distance that is approximately equivalent to the wheel track of a vehicle that is desired to be lifted. The transverse distance thus permits a vehicle's wheels to rest on top of runways (220). In some embodiments, runways (220) may include angled sloped ramps (not shown) or other features to facilitate rolling or driving a vehicle onto and off of runways (220). Of course, such a feature is entirely optional and may be omitted in other comments. Runways (220) may also include other features suitable to support a vehicle as will be apparent to one of ordinary skill in the art in view of the teachings herein. Some examples of additional and/or alternative features that may be incorporated into runways (220) and/or other features of lift system (200) are disclosed in U.S. Pat. No. 6,763,916, entitled “Method and Apparatus for Synchronizing a Vehicle Lift,” issued Jul. 20, 2004, the disclosure of which is incorporated by reference herein; U.S. Pat. No. 6,059,263, entitled “Automotive Alignment Lift,” issued May 9, 2000, the disclosure of which is incorporated by reference herein; U.S. Pat. No. 5,199,686, entitled “Non-Continuous Base Ground Level Automotive Lift System,” issued Apr. 6, 1993, the disclosure of which is incorporated by reference herein; U.S. Pat. No. 5,190,122, entitled “Safety Interlock System,” issued Mar. 2, 1993, the disclosure of which is incorporated by reference herein; U.S. Pat. No. 5,096,159, entitled “Automotive Lift System,” issued Mar. 17, 1992, the disclosure of which is incorporated by reference herein; and U.S. Pub. No. 2012/0048653, entitled “Multi-Link Automotive Alignment Lift,” published Mar. 1, 2012, the disclosure of which is incorporated by reference herein. It should be understood that that the teachings herein may be readily combined with the teachings of the various references cited herein.

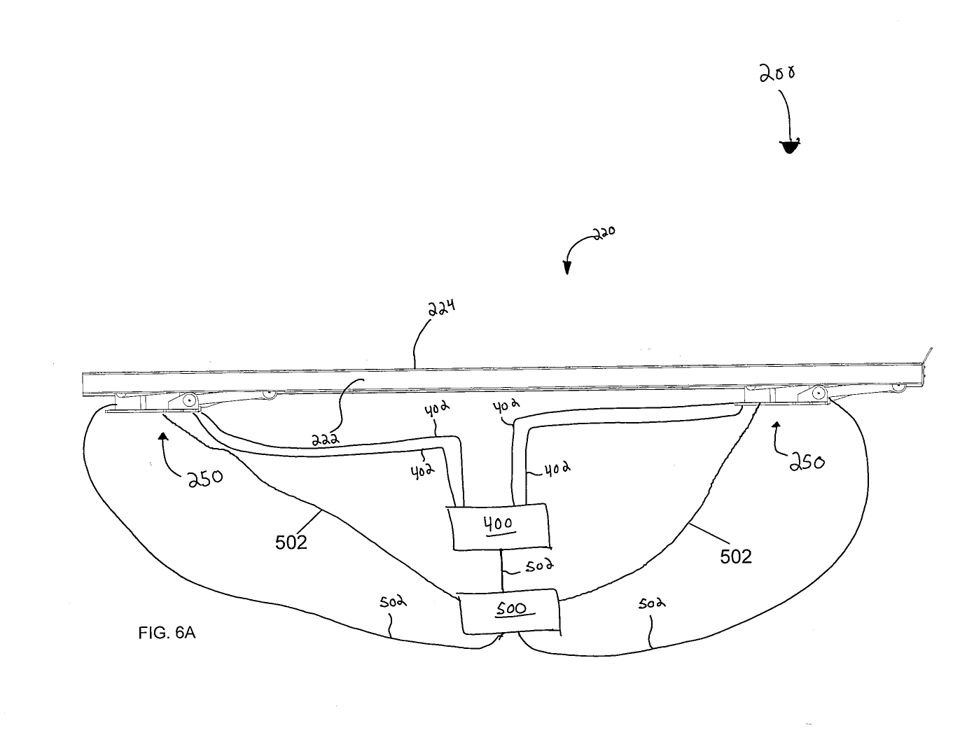

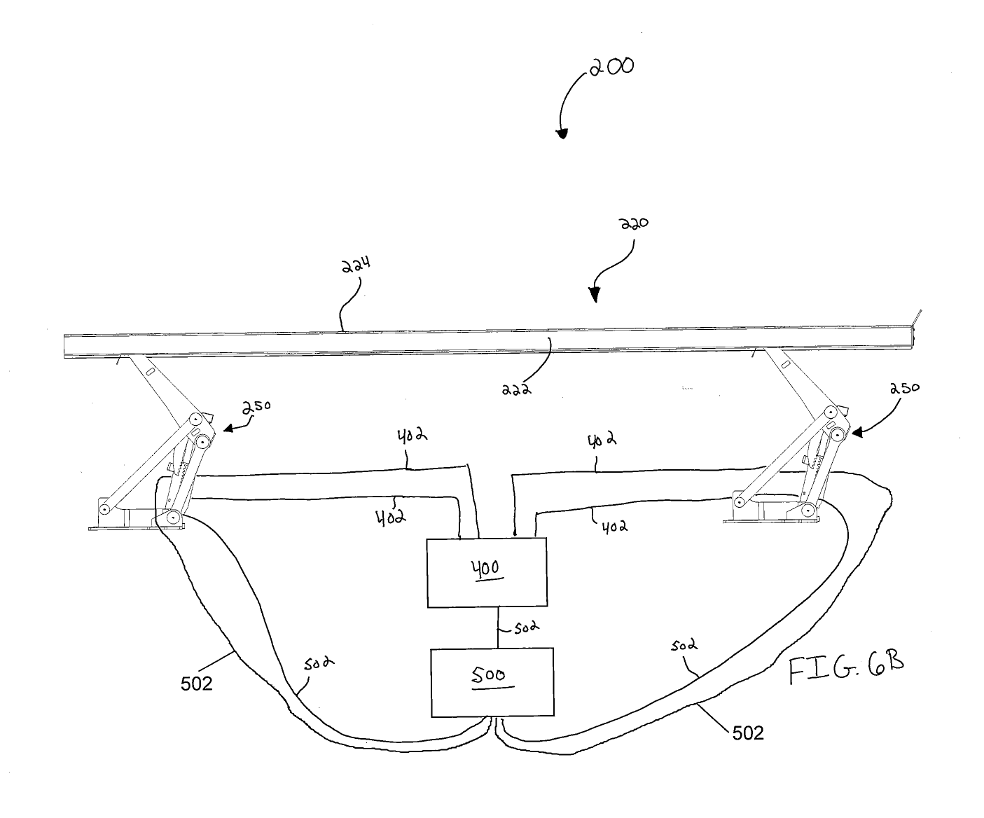

As can be seen in FIGS. 6A-6B, and as will be discussed in greater detail below, vehicle lift (200), by using runways (220) and lift assemblies (250), is operable to lift a vehicle vertically from a height approximately even with a shop floor to a desired working height. As will be understood, lift assemblies (250) are operable to lift runways (220) with substantially vertical movement of runways (220).

FIG. 7 shows an exploded view of lift assembly (250). Lift assembly (250) comprises a base (252), a linkage assembly (260), and an actuation assembly (350). Base (252) comprises a generally rectangular base plate (254) and two mounting brackets (257). Base plate (254) may be comprised of a rigid material such as steel, iron, aluminum, composite, or the like. Base plate (254) is shown as having a plurality of mounting holes (256). In the present example, mounting holes (256) may be used to receive bolts and/or other anchors to mount base plate (254) to a shop floor, thus providing a fixed platform for lifting assembly (250). In other examples, mounting holes (256) may be omitted entirely and base plate (254) may be secured to a shop floor by some other means such as welding, adhesive bonding, mechanical fastening, etc. Yet in other examples, mounting holes (256) may be used to secure lift assembly (250) to another surface such as a portable rack for vehicle lift systems (200) designed for smaller vehicles.

Mounting brackets (257) extend vertically from base plate (254). Mounting brackets (257) may be fixedly secured to base plate (254) by any suitable means such as welding, adhesive bonding, mechanical fastening, and/or the like. Alternatively, mounting brackets (257) may be integral to base plate (254). As can best be seen in FIG. 7, each mounting bracket (257) comprises a pair of mounting holes (258, 259). As will be described in greater detail below, components of linkage assembly (260) and actuation assembly (350) are rotatably coupled to mounting brackets (257).

Mounting holes (258, 259) are positioned at each end of mounting bracket (257). In particular, a rear mounting hole (258) is positioned near the rear of mounting bracket (257), and a front mounting hole (259) is positioned near the front of mounting bracket (257). Rear mounting hole (258) is positioned vertically higher than front mounting hole (259). As will be understood in view of the description below, mounting holes (258, 259) are oriented such that linkage assembly (260) and actuation assembly (350) are operable to fold up, thus minimizing the height of vehicle lift system (200) when vehicle lift system (200) is in the retracted position as shown in FIG. 6A. Accordingly, the shape of mounting brackets (257) is configured to arrange mounting holes (258, 259) in the positions described above. Thus, although mounting brackets (257) are shown as having a particular shape, mounting brackets (257) may be of any suitable shape as will be apparent to those of ordinary skill in the art in view of the teachings herein.

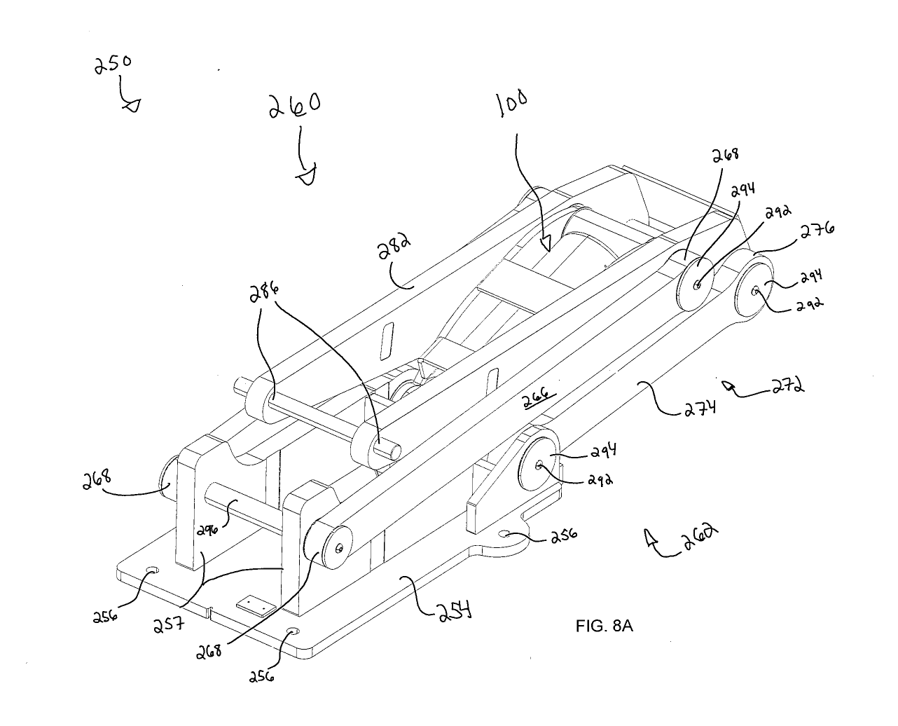

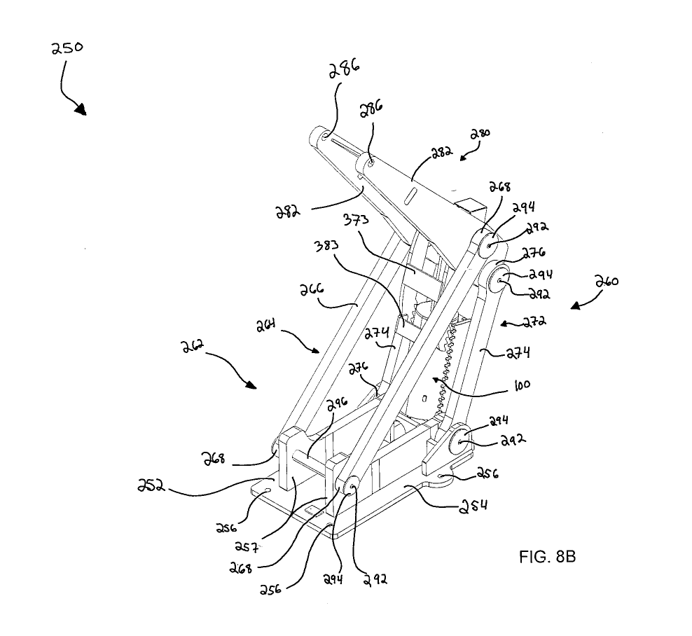

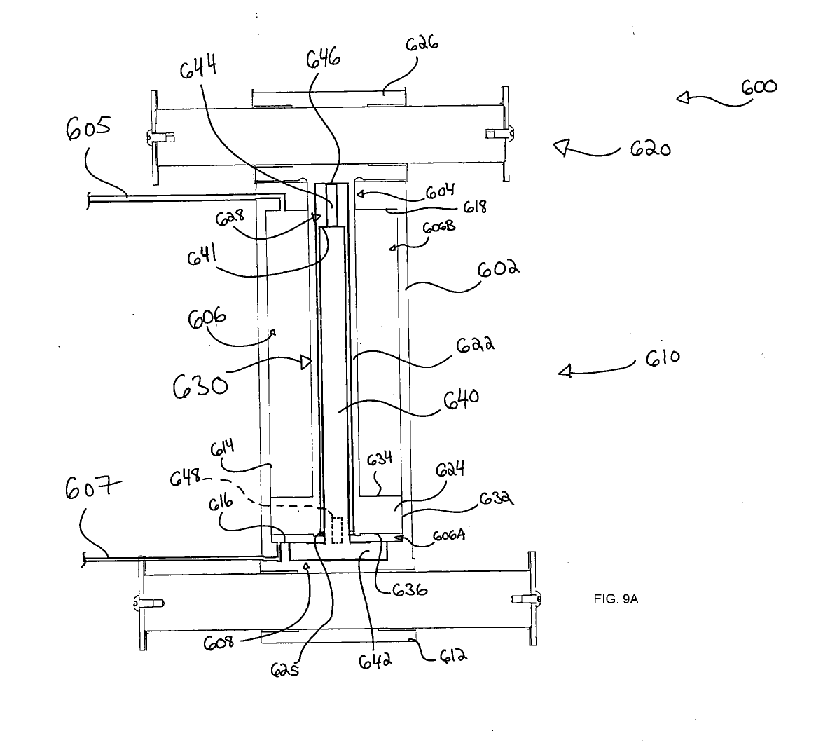

Turning to FIGS. 8A-8B, linkage assembly (260) comprises a set of four lower links (262) and a third pair of armatures (282). Lower links (262) comprise a first pair of armatures (264) and a second pair of armatures (272). First armatures (264) are generally similar, having the same size and shape, and comprising an elongated portion (266) positioned between two rounded end portions (268). Likewise, second armatures (272) are generally similar, having the same size and shape, and comprising an elongated portion (274) positioned between two rounded end portions (276). Although they differ in shape, the rounded end portions (268, 276) of lower links (262) each comprise bores (270, 278) that permit the first and second pairs of armatures (264, 272) to be respectively attached to pins (296, 298) associated with mounting brackets (257) at one end, and pins (300, 302) associated with third armatures (282) at another end. It should be noted that each pair of rounded end portions (268, 276) do not necessarily have equal dimensions.

As can be seen in FIGS. 8A-8B, first armatures (264) are generally longer in length relative to second armatures (272). As will be described in greater detail below, the greater length of first armatures (264) relative to second armatures (272) is generally necessitated by the configuration of linkage assembly (260). Although lower links (262) are shown as having a certain length, it should be understood that their lengths may be varied depending on the design specifications of vehicle lift system (200). For instance, some vehicle lift systems (200) may be designed to have a higher or lower working height. Thus, longer or shorter lower links (262) may be used to increase or decrease the range of motion of lift assembly (250), respectively.

Elongated portions (266, 274) of lower links (262) are generally rectangular in shape. Alternatively, any suitable shape may be used, such as an elongated rod, elongated hexagon, hollow tubing, or the like. Rounded end portions (268, 276) are generally circular to accommodate bores (270, 278) and generally reduce the area occupied by rounded end portions (268, 276). In other examples, rounded end portions (268, 276) may have any suitable shape. Lower links (262) are relatively rigid and may be comprised of any suitable material such as steel, iron, aluminum, composite, or the like. Of course, lower links (262) may have any other suitable configuration and composition as will be apparent to those of ordinary skill in the art in view of the teachings herein.

Third armatures (282) are generally the same size and shape. In particular, each third armature (282) is approximately rectangular and includes a taper from one end to another. The front end of third armature (282) is wider relative to the rear end to accommodate two connecting bores (284, 285). As will be described in greater detail below, upper connecting bore (284) and lower connecting bore (285) are used to rotatably couple lower links (262) to third armatures (282) via pins (300, 302) respectively. As will also be described in greater detail below, connecting bores (284, 285) are positioned on third armature (282) to provide pivot points about which lower links (262) may pivot relative to third armature (282). The rear end of third armature (282) is rounded and includes an attachment bore (286). Attachment bore (286) is positioned to permit rotatable coupling between third armature (282) and runway (220) via pin (304) and pin blocks (not shown).

As can best be seen in FIG. 7, lift assembly (250) includes a plurality of pins (296, 298, 300, 302) that rotatably couple various components of lift assembly (250). In particular, bore (270) of the lower portion of first armatures (264) is rotatably coupled to rear mounting holes (258) of mounting brackets (257) via pin (296). Pin (296) may be welded or fixed to mounting bracket (257) of base (252) by any suitable methods as will be apparent to one of ordinary skill in the art in view of the teachings herein. Bore (278) of the lower portion of second armatures (272) is rotatably coupled to front mounting holes (259) of mounting brackets (257) via pin (298). Pin (298) may be welded or fixed to mounting bracket (257) of base (252) by any suitable methods as will occur to one of ordinary skill in the art in view of the teachings herein. Alternatively, pin (298) may rotate freely relative to mounting bracket (257). As described above, pin (298) at this joint also rotatably couples to attachment feature (112) of hydraulic actuator assembly (100). Similarly, another pin (300) provides rotatable coupling between upper connecting bore (284) of third armatures (282), bores (270) of the upper portions of first armatures (264), and sleeve (362). As described above, pin (300) at this joint also rotatably coupled attachment feature (126) of hydraulic actuator assembly (100). Finally, bores (278) of the upper portions of second armatures (272) are rotatably coupled to lower connecting bore (285) of third armatures (282) via pin (302). Pin (302) may be welded or fixed to third armatures (282) by any suitable methods as will occur to one of ordinary skill in the art in view of the teachings herein. Pins (296, 298, 300, 302) are shown as being fastened to their respective mating parts using bolts (292) and washers (294). Of course, pins (296, 298, 300, 302) may be fastened to their respective mating parts by any other suitable means. Although not shown, it should be understood that the various joints described above may also include bushings, bearings, or other devices suitable to reduce friction between the various parts.

FIGS. 8A-8B show linkage assembly (260) and base (252) in an exemplary mode of operation as the linkage assembly (260) transitions from the retracted position to an extended position. It should be understood that the combination of mounting brackets (257), lower links (262), and third armatures (282) forms a four-bar linkage such that rotation of lower links (262) is operable to produce substantially vertical motion of attachment bore (286) of third armatures (282).

FIG. 8A shows linkage assembly (260) in the retracted position. As can be seen, lower links (262) and third armatures (282) are configured to fold relative to each other so that the lower links (262) and third armatures (282) have limited vertical extension. Additionally, hydraulic actuator assembly (100) is in the withdrawn position. Accordingly, when linkage assembly (260) is in the retracted position, runway (220) is relatively close to ground level. Additionally, in the retracted position, lower links (262) and third armatures (282) are nearly parallel with each other.

FIG. 8B shows linkage assembly (260) in the extended position. As described above, the extended position of linkage assembly (260) corresponds to runway (220) being raised to a desired working height. In the operation of transitioning between the retracted position and the extended position, pin (300) is forced away from pin (298) via extension of linear activating assembly (120). Because linkage assembly (260) is a four-bar linkage, forcing pin (298) away from pin (300) causes lower links (262) to simultaneously rotate about pins (296, 298) and pivot third armatures (282) about a point between the center of pins (300, 302). The pivoting action of third armatures (282) causes attachment bores (286) of third armatures (282) to move upwardly. It should be understood that the motion of attachment bores (286) is substantially vertical as lift assembly (250) transitions from the retracted position to the extended position. Of course, the precise path of lift assembly (250) may vary depending on a number of factors such as the length of each armature (264, 272, 282), the relative lengths of armatures (264, 272, 282), and other similar factors.

As mentioned above and shown in FIGS. 5-8B, each lift assembly (250) includes a hydraulic actuator assembly (100). Each hydraulic actuator assembly (100) is in fluid communication with pump (400) via a pair of hydraulic hoses (402). Hydraulic hoses (402) and pump (400) may provide fluid communication to fluid channels (105, 107) in the same or similar fashion as described above in order to move linear actuating assembly (120).

Each hydraulic actuator assembly (100) is in electrical communication with control circuit (500) via communication wires (502). In the current example, communication wires (502) are connected to rotation sensor (140) of each hydraulic actuator assembly (100). Communication wires (502) may also be in electrical communication with other aspects of each lift assembly (250).

Communication wires (502) may be configured to provide electrical power from circuit board (500) to rotation sensor (140). Additionally, rotation sensor (140) may be able to communicate the rotational displacement of rotating element (142) relative to static element (148). As mentioned above, the rotational displacement of rotation element (142) relative to static element (148) corresponds to the linear displacement of linear actuating assembly (120) relative to cylinder assembly (110). Therefore, circuit board (500) may be configured to determine the linear displacement of linear actuating assembly (120) relative to cylinder assembly (110) through a predetermined formula based on dimensions of hydraulic actuator assembly (100). Additionally, the linear displacement of linear actuating assembly (120) relative to cylinder assembly (110) may correspond with a predetermined height of the portion of lift assembly (250) directly connected to runways (220) based on the dimensions of lift assembly (250). Therefore, circuit board (500) may be configured to determine the vertical height of the portion of lift assembly (250) connected to runways (220), or any other suitable portion of lift assembly (250) as will be apparent to one having ordinary skill in the art in view of the teachings herein.

Circuit board (500) is also in electrical communication with pump (400). Circuit board (500) may control the amount of hydraulic fluid that pump (400) distributes to individual hydraulic actuator assemblies (100). Therefore, circuit board (500) may control the individual heights of each hydraulic actuator assembly (100). For example, circuit board (500) may determine individual heights of each lift assembly (250) in order to determine the lowest lift assembly (250). Circuit board (500) may then calculate the difference of the heights of each of the other three lift assemblies (250) in order to equal the lowers lift assembly (250). Circuit board (500) may then communicate instructions to pump (400) in order to adjust the three, higher, lift assemblies (250) to lower accordingly to equalize the height of each lift assembly (250). Therefore, communication between linear displacement measuring assembly (130), circuit board (500), and pump (400) may help keep vehicle lift system (200) level.

Of course, utilizing the lowest lift assembly (250) as the datum point is just one option. Circuit board (500) could determine the highest lift assembly (250). Circuit board (500) may then calculate the difference of the heights of each of the other three lower lift assemblies (250) in order to equal the highest lift assembly (250). Circuit board (500) may the communicate instructions to pump (400) in order to adjust the three, lower, lift assemblies (250) to raise accordingly to equalize the height of each lift assembly (250). Any other suitable means of equalizing the height of each lift assembly (250) may be utilized as would be apparent to one having ordinary skill in the art in view of the teachings herein.

It should be understood that while in the current example, hydraulic actuator assembly (100) is used in vehicle lift system (200), hydraulic actuator assembly (600, 700) may be readily incorporated into vehicle lift system (200) in place of hydraulic actuator (100).

While in the current example, vehicle lift system (200) includes linkage assemblies, armatures, and pins, any other suitable vehicle lift system having a linear displacement measuring assembly (130) in communication with a circuit board (500) lift assembly (250).

Although actuation assembly (350) is shown as being hydraulically actuated, it should be understood that any suitable device may be used to actuate lift assembly (250). For instance, actuation assembly (350) may comprise a linear actuator having a lead screw and a motor, a pneumatic actuator, spring loaded actuator, or any other suitable actuator as will be apparent to those of ordinary skill in the art in view of the teachings herein.

The illustrated embodiment is double-acting; that is, it uses pressure fluid on both sides of plunger (124) in cylinder (102), and the pressure differential between the two sides moves plunger (124) axially through the cylinder (102). In alternative embodiments, cylinder (102) is single-acting, where there is fluid on only one side of the plunger (124) (e.g., between plunger (124) and head end (118)), and the other side of the plunger (124) (e.g., between plunger (124) and base end (116)) is air- or gas-filled or even vented. In such embodiments, fluid channel (105) is a breather that leads air in and out, and fluid channel (107) is a pressure line/return line.

What is claimed is:

1. A vehicle lift system, comprising:
a support member that supports at least part of a vehicle;
a fluid-filled cylinder configured to raise and lower the support member, wherein the fluid- filled cylinder defines a chamber, wherein the fluid-filled cylinder comprises:
an actuating member that translates inside the chamber of the fluid-filled cylinder as the fluid-filled cylinder expands or contracts through at least part of its stroke; and
a sensor at least partially fixed relative to the chamber, wherein the sensor is configured to detect a linear position of the actuating member inside the chamber; and
a controller in communication with the sensor to receive a signal indicative of the linear position of the actuating member, wherein the controller is configured to control the height of the support member responsively to the signal.

2. The vehicle lift system of claim 1, wherein the fluid-filled cylinder is connected to the support member through a scissor mechanism.

3. The vehicle lift system of claim 1, wherein the fluid-filled cylinder operates vertically to lift the support member.

4. The vehicle lift system of claim 1, wherein the fluid-filled cylinder is connected to the support member through a parallelogram linkage.

5. The vehicle lift system of claim 1, wherein the controller controls the height of the support member in relation to the corresponding height of one or more other support members.

6. The vehicle lift system of claim 1, wherein the sensor comprises a string potentiometer.

7. The vehicle lift system of claim 6, wherein:
the string potentiometer comprises a measuring cable, and
the measuring cable is fixed the actuating member.

8. The vehicle lift system of claim 7, wherein:
the string potentiometer comprises a body partially housing the measuring cable,
the measuring cable is configured to extend and retract from the body, and
the body is fixed relative to at least one portion of the chamber.

9. The vehicle lift system of claim 1, wherein the sensor comprises a linear variable differential transformer.

10. The vehicle lift system of claim 9, wherein:
the actuating member comprises a rod,
the linear variable differential transformer comprises a coil assembly and a core member,
the core member is fixed relative to the rod, and
the core member is slidably housed within the coil assembly.

11. The vehicle lift system of claim 10, wherein the rod defines a channel, and the core member is within the channel.

12. The vehicle lift system of claim 11, wherein the rod further comprises a shaft extending within the channel, and the core member is fixed to the shaft.

13. The vehicle lift system of claim 12, wherein the actuating member comprises a seal within the channel.

14. The vehicle lift system of claim 13, wherein the coil assembly defines an opening, wherein the seal is configured to prevent hydraulic fluid from entering the opening.

15. The vehicle lift system of claim 14, wherein the seal is fixed relative to the rod.

16. A vehicle lift system comprising:
(a) a support member that supports at least part of a vehicle;
(b) a fluid-filled cylinder assembly configured to raise and lower the support member, wherein the fluid-filled cylinder assembly comprises:
(i) a cylinder defining a cavity, and
(ii) an actuating member slidably housed within the cavity of the cylinder, wherein the actuating member comprises a rod and a plunger, and the actuating member is configured to linearly actuate relative to the cylinder; and
(c) a sensor at least partially located within the cavity, wherein a first portion of the sensor is fixed to the cavity, wherein a second portion of the sensor is fixed to the actuating member.

17. The vehicle lift system of claim 16, wherein the sensor comprises a string potentiometer.

18. The vehicle lift system of claim 17, wherein the string potentiometer comprises a measuring cable fixed to the plunger.

19. The vehicle lift system of claim 16, wherein the sensor comprises a linear variable differential transformer.

20. A vehicle lift system comprising:
(a) a support member that supports at least part of a vehicle;
(b)a fluid-filled cylinder assembly configured to raise and lower the support member, wherein the fluid-filled cylinder assembly comprises:
(i) a cylinder defining a cavity, and
(ii) an actuating member slidably housed within the cavity of the cylinder, wherein the actuating member is configured to linearly actuate relative to the cylinder;
(c) a sensor at least partially located within the cavity, wherein
a first portion of the sensor is fixed to the cavity,
a second portion of the sensor is fixed to the actuating member, and
the sensor is configured to measure a linear position of the actuating member relative to the cylinder; and
(d) a controller in communication with the sensor to receive a signal indicative of the linear position, wherein the controller is configured to responsively control the height of the support member.
